(19) United States
(12) Patent Application Publication
(10) Pub. No.: US 2025/0053617 A1
(43) Pub. Date: Feb. 13, 2025

(54) TRANSACTION EXEMPLARS FOR MACHINE LEARNING

(71) Applicant: Steady Platform LLC, Atlanta, GA (US)

(72) Inventors: Tyler Howard, Atlanta, GA (US); Andrew Toloff, Atlanta, GA (US); Jason Robinson, Atlanta, GA (US)

(21) Appl. No.: 18/446,538

(22) Filed: Aug. 9, 2023

(51) Int. Cl. G06F 18/2325; G06F 18/2413

(52) U.S. Cl. CPC G06F 18/2325; G06F 18/2413

(57) ABSTRACT

Provided are systems and methods which can use machine learning to draw additional inferences about transaction records from transaction strings. In one example, a method may include converting a plurality of transaction strings corresponding to a plurality of transactions into a plurality of vectors in multidimensional vector space, respectively, via execution of a machine learning model, identifying a cluster of vectors in the multidimensional space that correspond to a subset of transactions among the plurality of transactions that are related based on distances between the cluster of vectors in the multidimensional space, identifying a representative vector within the cluster that corresponds to an exemplary transaction of the subset of transactions based on the cluster of vectors, and storing the representative vector within a data store.

### BACKGROUND

When a financial account is used in a financial transaction, for example, a payment to another, receipt of funds, transfer of funds, etc., a record is typically created by the financial institution that issued the financial account. The transaction record may include a transaction string embodied as a collection of text that provides details about a financial transaction. In particular, that transaction string may include some helpful features about the transaction such as a date of the transaction, a location of the transaction, a type or purpose of the transaction, and in some cases, an identifier of a counterparty entity (e.g., the entity that owns the other account) involved in the transaction.

Transaction strings in raw format often contain a significant amount of variability. For example, two payment transactions from an employer to an employee may cause the financial institution to create two different transaction strings with significantly different content, such as different substrings, different account identifiers, different dates, different locations, and the like. The variability within the transaction strings makes it difficult to categorize, cluster, and/or group transactions together for extracting meaning from these groups and/or performing further processing.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A-1B are diagrams illustrating a host platform that is configured for categorizing transactions in accordance with example embodiments.

FIGS. 2A-2B are diagrams illustrating a process of cleaning transaction strings in accordance with example embodiments.

FIGS. 3A-3C are diagrams illustrating a process of building a classifier via machine learning in accordance with example embodiments.

FIG. 4 is diagram illustrating batch processing of transaction records using the classifier in accordance with example embodiments.

FIGS. 5A-5D are diagrams illustrating a process of generating transaction exemplars in accordance with example embodiments.

FIG. 6 is a diagram illustrating a process of mapping transaction exemplar candidates to a transaction exemplar in accordance with an example embodiment.

FIG. 7A is a diagram illustrating a process of generating transaction exemplars in accordance with an example embodiment.

FIG. 7B is a diagram illustrating a process of categorizing transactions based on previously generated transaction exemplars in accordance with an example embodiment.

FIG. 8 is a diagram illustrating a method for generating a transaction exemplar in accordance with an example embodiment.

FIG. 9 is a diagram illustrating an example of a computing system for use in any of the examples described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a reader with a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

Financial transactions (i.e., transactions) are events that represent the movement of money from one party to another. A financial institution (e.g., a bank, investment firm, or the like) account may include a document, file, spreadsheet, printout, digital user interface, or the like, with the history of transactions over a period of time in the form of transaction records. Transaction records can include several pieces of data, for example, a date of the transaction, an amount of the transaction, whether it was a credit or debit, a location of the transaction, and the corresponding transaction string. As described herein, a transaction string is a collection of text that provides additional detail about the transaction and might include additional date information, location information, and ideally a description of the other entity (or “counterparty”) involved in the transaction (aside from the owner of the financial account). Transaction strings are typically unique to a particular financial institution that creates the transaction string. Each financial institution may use different content, different ordering, different variability, and the like, within a transaction string.

As a simple motivating example, multiple credit transactions from the same counterparty to the same depository account may be considered a “deposit source” or “recurring deposit source”. The text of transaction strings received from a single deposit source to a single bank account will still contain variability. Deposit sources may represent different financial agreements. For example, a common deposit source is termed or classified as “payroll”, which occurs when an employer deposits a paycheck on a recurring basis into an employee's bank account. However, a given deposit source is not necessarily classified as payroll. Other examples of deposit sources include, but are not limited to, peer-to-peer, basic income, mortgage payments, grants, childcare, alimony, and the like. It should be further appreciated that an employer or counterparty can deposit payroll payments to multiple accounts for the same individual, and that different counterparties could still represent the same deposit source, for example, in the case of peer-to-peer payments for a common type of service rendered. Moreover, transactions can be classified in categories that are not necessarily deposit sources, for example, transfer transactions indication the movement of funds between accounts. The discussion is not meant to be limited to transactions corresponding to deposit sources.

In the example embodiments, a machine learning system can identify a category such as a deposit source from a transaction string (e.g., whether the transaction can be classified as arising from payroll, peer-to-peer, basic income, mortgage payment, grant, childcare, alimony, etc.). The machine learning system can label each transaction string with its identified category (e.g., deposit source, etc.), thereby increasing the amount of data available for further processing and interpretation of the transaction string. In particular, a deposit source classifier model (e.g., a machine learning classification model based on algorithms including, but not limited to, decision trees, boosting, bagging, discriminant analysis, Naïve Bayes, support vector machines, neural networks, etc.), may learn from a plurality of transaction strings to identify which deposit source category applies to the transaction strings. Additional machine learning algorithms and processing steps, including clustering (e.g. k-means), topic modeling (e.g. Latent Dirichlet Allocation (LDA)), dimensionality reduction (e.g. Principal Component Analysis (PCA), Singular Value Decomposition (SVD), Independent Component Analysis (ICA)), etc. can be performed on a plurality of the transactions to preprocess, pre-group, and/or filter transactions for processing in a system, pipeline, or ensemble of machine learning transactions, to further aid the deposit source classifier model in performing classifications of transaction strings. The machine learning system may then generate a classifier for classifying future or otherwise additional transaction strings based on the identified deposit sources. For example, this processing methodology can determine patterns of correlation with the derived category and automatically apply these findings to all identified historical and future transactions from a given deposit source.

The classifier created by the machine learning system described herein may be used to classify transaction records. During this process, each transaction record may receive an addition label identifying its deposit source. Furthermore, additional machine learning can be used to process the “enhanced” transaction records to identify additional aspects of the transactions such as counterparties. Also, additional verifications such as income verification can be performed for a user based on such enhanced transaction strings. For example, a person may claim that they make a particular amount of income, such as could be claimed by a person applying for a government benefit or the like. The machine learning system described herein can quickly identify sources of income for the user, and also determine the types of such income. Furthermore, the machine learning system can differentiate between what might be termed “earned” income or payroll income versus other classes of income, such as basic income, alimony, gambling winnings, income from other government benefit programs, grants, other types of income related to employment, other types of work-related income, and the like. This differentiation allows the host platform described herein to determine and verify whether the user is eligible for such a benefit, depending on thresholds, earning requirements, and other program considerations.

In addition, the example embodiments are also directed to a machine learning service that is capable of identifying transaction “exemplars”. Transactions are machine generated string values that generally have fixed sources of variation including (1) a transaction source and (2) a recipient financial institution (FI). The transaction source is generally a company of some kind, like a bank, an employer, a payment processor, etc. The recipient FI is often a bank, such as a bank used by a registered member or user of the software application described herein. The recipient FI and the source may be discoverable in many cases.

In the example embodiments, for any set of transaction record data, the system can automatically find subsets of transaction records that resemble each other without labeling them as such a priori. Thus, models can be learned to enrich transaction records in various ways, including but not limited to automatically classifying new transactions to their respective subsets, or clusters. Moreover, these models may be artificial intelligence (AI) models, machine learning (ML) models, heuristics, structured templates encoding patterns, or the like. Clusters with small variance on a relative basis, i.e., as compared to other potential clusters that could be formed by the transaction data, can be represented by an exemplar for each given type of transaction, and named as such. Generally, this difference is referred to as small within-cluster or intra-cluster variance, as compared with between-cluster or inter-cluster variance, as measured in a relevant n-dimensional space.

The exemplars may be generated in vector space as further described in the examples herein. As just one example, a centroid of the cluster may be used as an exemplar of the cluster. As another example, a transaction within the cluster may be used as the exemplar of the cluster. The clusters may be identified, for example, based on Euclidean distances within the vector space that are identified and used by the AI/ML models.

In some embodiments, the machine learning system described herein may be hosted on a host platform which may include or otherwise be coupled with a blockchain network of distributed computing machines or virtual machines. However, embodiments are not limited thereto. In addition to the blockchain network or instead of the blockchain network, the host platform may include a cloud platform, a web server, a distributed network of servers, one or more databases for storing input and output data created by machine learning models, and the like.

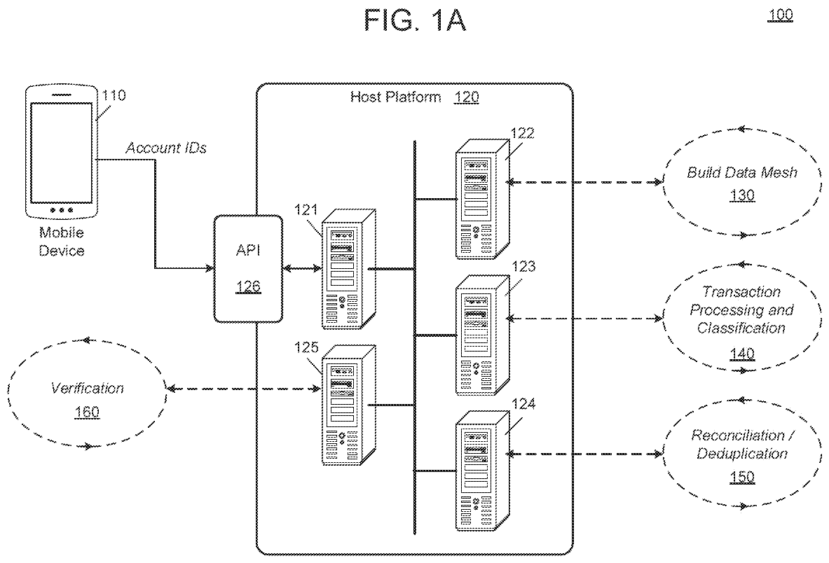

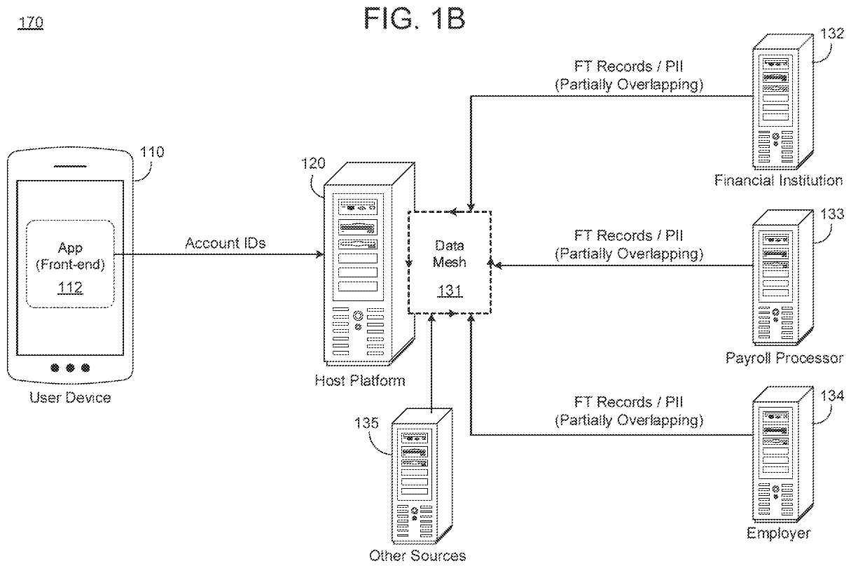

FIGS. 1A-1B illustrate examples of a host platform 120 that is configured for eligibility verification and benefit administration in accordance with example embodiments. As an example, the host platform 120 may include one or more of an application server, a cloud platform, a blockchain network, and the like. In this example, the host platform 120 is a distributed system (e.g., blockchain network, distributed database, etc.) with a plurality of peers 121, 122, 123, 124, and 125. However, embodiments are not limited to a decentralized architecture, but may also include a centralized architecture. In this example, each of the peers 121-125 may include a software installed therein that establishes a shared ledger (e.g., blockchain ledger, etc.) and provides address information (e.g., URLs for accessing, etc.) for each of the peers 121-125. Also, the peers 121-125 may cooperate in the management of the shared ledger.

In the example embodiments, the host platform 120 may execute one or more verifications of a user, such as income verification, identity verification, benefit administration eligibility verification, and the like. In FIG. 1A, a peer 122 ingests data from multiple sources and builds a data mesh 130 as further described in the example of FIG. 1B. To perform this process, a user may upload, enter, or otherwise specify account IDs via a mobile device 110. The account IDs may be received via an application programming interface (API) 126 of the host platform 120. In response, the host platform 120 may pull/retrieve data from financial accounts such as bank account statements, debit card statements, credit card statements, account summaries, and the like.

The ingested account data may include transaction records with information such as transaction strings, payment amounts, payment dates, geographic location data of the transaction, etc. The ingested data may be enhanced according to various embodiments prior to and/or during any verifications being performed in order to further improve the accuracy of the verifications. For example, the host platform may perform a deposit source classification process 140 on the transaction records using transaction strings within the transaction records. The deposit source classification process 140 may involve building or leveraging a classifier with the capability of labeling transaction strings using a plurality of predefined categories of transactions (e.g., a plurality of income source types, deposit source types, etc.) using machine learning. As a non-limiting example, the categories may include deposit source classifications that specify a type of credit associated with a payment/credit to the user's account. The categories of such deposit sources may include, but are not limited to, payroll, peer-to-peer, alimony, childcare, basic income, grants, miscellaneous, and the like.

Although not shown in FIG. 1A, the host platform may also use machine learning during this stage to identify a counterparty of each transaction. In this example, the transactions refer to credit transactions that deposit money into a user's account. The “counterparty” in this example refers to the other entity in the transaction (i.e., the payor) who pays the money to the user's account. Machine learning can be used to perform such processes. An example of counterparty identification using machine learning is described in U.S. patent application Ser. No. 17/342,622, filed on Jun. 9, 2021, in the United States Patent and Trademark Office, and in U.S. patent application Ser. No. 17/867,958, filed on Jul. 19, 2022, in the United States Patent and Trademark Office, which are fully incorporated herein by reference for all purposes.

For example, the exemplars can be used in the translation service of the host Platform shown in co-pending Ser. No. 17/342,622 to apply exemplars to classify transactions, as part of the machine learning process and models that are used therein.

The host platform 120 may also perform a reconciliation and/or deduplication process 150 to further enhance the ingested transaction records. For example, reconciliation may identify whether two transaction records are from the same transaction (i.e., refer to or are part of the same payment, etc.). As another example, the reconciliation process may identify whether the two transaction records are from two different entities (i.e., a payee and a payor, etc.), such that the two transaction records are from the same transaction, but from different perspectives. In this case, the reconciliation process may modify one of the transaction records to include the date from the other transaction record to create a bigger transaction record. To identify whether two or more transactions are duplicates, a deduplication process can be performed to find and then remove duplicates before further processing is performed on the ingested transaction records. An example of reconciliation and deduplication is described in U.S. patent application Ser. No. 17/835,044, filed on Jun. 8, 2022, in the United States Patent and Trademark Office, which is fully incorporated herein by reference for all purposes.

The processed transaction records, including any deposit source identification, counterparty identification, and/or reconciliation and deduplication, may be further processed for purposes of verifying the user of the transaction records. For example, one or more verification processes 160 may be executed by the host platform 120 to verify aspects of the user such as income, identity, eligibility for benefits, and the like. Examples of the verification processes are described in U.S. patent application Ser. No. 17/580,721, filed on Jan. 21, 2022, which is fully incorporated herein by reference for all purposes.

FIG. 1B illustrates a process 170 for building a data mesh from ingested data in accordance with example embodiments. This ingested data can contain transaction records, PII, and the like, and sources may have overlaps among each other. Before transaction records can be verified, the host platform 120 may build a data mesh 131 based on account data and other data of a user that is ingested from one or more sources. In this example, the ingested data is pulled from a financial institution server 132, a payroll processor server 133, and an employer server 134, via APIs, etc. Here, a front-end 112 of a software application hosted according to various embodiments may be downloaded from a marketplace, etc., and installed on the mobile device 110 such as a smart phone, a tablet, a laptop, a personal computer, etc. It should also be appreciated that the host platform 120 may host a web application, a website, an authentication portal, or the like, which could involve verifying a user online.

In this example, a user may input account numbers/routing numbers or login credentials of bank accounts, employer accounts (e.g., gig employers, etc.), payroll company accounts, credit accounts, etc., held by trusted sources of truth, such as banks, credit agencies, payroll processors, employers/organizations, institutions, and the like, into one or more input fields displayed within a user interface of the front-end 112 of the application and submit them to the host platform 120 by clicking on a button within the user interface of the front-end 112. For example, the mobile device 110 and the host platform 120 may be connected via the Internet, and the front-end 112 may send the information via an HTTP message, an application programming interface (API) call, or the like. When the account identifiers and/or other credentials are transmitted, a response containing relevant account information and the like may be received.

In response to receiving the account information, the host platform 120 may register/authenticate itself with various trusted sources of truth where the accounts/user accounts are held/issued. For example, the host platform may perform a remote authentication protocol/handshake with the financial institution server 132, the payroll processor server 133, and the employer server 134, another data source 135, and the like, based on user account information that includes an account issued by the bank, a source of funds from the payroll processor, and an employer that pays the user. These accounts provide the host platform with the fundamental building blocks for constructing a unique mesh (data mesh 131) of partially-overlapping data sets that can be combined into one larger data set and analyzed. In the example embodiments, the combination of data from the different sources of truth (e.g., financial institution server 132, payroll processor server 133, employer server 134, and other sources 135) can be assembled into the data mesh 131 by the host platform 120. It should also be appreciated that the user may manually upload data such as documents, bank statements, account credentials, and the like, in a format such as a .pdf, .docx, spreadsheet, XML file, JSON file, etc. Furthermore, optical character recognition (OCR) may be performed on any documents, files, bank statements, etc. obtained by the host platform 320 to extract attributes from such documents and files.

The authentication process may include one or more API calls being made to each of the different third-party services (bank, payroll, employer, etc.) via a back-end of the software application on the host platform 120 to establish a secure HTTP communication channel. For example, the back-end of the software application may be embedded or otherwise provisioned with access credentials of the user for accessing the different third-party services. The back-end may then use these embedded, provisioned, and/or otherwise securely stored credentials to establish or otherwise authenticate itself with the third-party services as an agent of the user. Each authenticated channel may be established though a sequence of HTTP communications between the host platform 120 and the various servers. The result is a plurality of web sessions between the host platform 120 and a plurality of servers, respectively. The host platform 120 can request information/retrieve information from any of the servers, for example, via HTTP requests, API calls, and the like. In response, the user data can be transmitted from the servers to the host platform 120 where it can be combined into the data mesh 131 for further processing.

In some embodiments, the host platform 120 described herein may include or otherwise be coupled to a blockchain network which may be a public blockchain network or a permissioned/private blockchain network. Examples of the types of blockchain frameworks that can be used include Ethereum, Solana, EOS, Cardano, Hyperledger Fabric, and the like. As an example, an application server may host a mobile application or web application that provides the verification processes described herein. The application server may be coupled to a blockchain network and may transmit results of the verification processes and confirmations of the payments to a blockchain ledger of the blockchain network. The blockchain network may include a plurality of blockchain-enabled peers (e.g., distributed computing machines, virtual machines, etc.) that work together to write to and/or manage the blockchain ledger.

Each of the blockchain-enabled peers may be a member of the blockchain network and may include a local copy of the blockchain ledger. Depending on the choice of blockchain protocol employed for the particular application, the peers may execute consensus based protocols and network-wide communications including gossip to ensure that no single peer can update the blockchain ledger by themselves and also to ensure that a state of the content stored in the blockchain(s) on the local blockchain ledgers of all of the peers is the same/synchronized. Furthermore, to ensure that the blockchain ledger is “immutable” and cannot be changed, each new block added to the ledger may include a hash pointer to an immediately previous block on the blockchain ledger. For example, a committing peer may hash a value from the previous block (e.g., a block header, block data section, block metadata, or the like) and store the hash value in the new block (e.g., in a block header, etc.).

The blockchain-enabled peers may be trusting entities or untrusting entities with respect to each other. In some embodiments, the blockchain-enabled peers may work together to achieve a consensus (i.e., an agreement) on any data that is added to the blockchain ledger before it is committed. In some cases, peers may have different roles and peers may have multiple roles. As an example, a committing peer refers to a peer that stores a local copy of the blockchain ledger and commits blocks locally to its instance of the blockchain ledger. Most if not all peers in the blockchain network may be committing peers. Prior to the data being committed, peers execute a consensus process of some kind to ensure that the requirements for adding the data to the blockchain ledger (e.g., specified by policy of the blockchain, etc.) has been satisfied. Examples of consensus processes include proof of work, endorsement, proof of stake, proof of history, and the like.

An ordering service or ordering peer may receive transactions which are to be added to the blockchain and order the transactions based on priority (e.g., time of receipt, etc.) into a block. After the block is filled, the ordering service may generate a new block and distribute the block to the committing peers.

In some embodiments, blockchain transactions may require “endorsement” by at least a small subset of peers within the blockchain network before being added to a new block. In this example, an “endorsing” peer may receive a new blockchain transaction to be stored on the blockchain ledger, and perform an additional role of simulating content (e.g., within the blockchain transaction) based on existing content stored on the blockchain ledger to ensure that the blockchain transaction will not have issues or fail. The endorsement process may be performed prior to adding the blockchain transaction to the block by the ordering service. Thus, in that case, only “endorsed” transactions may be added to a new block to be committed to the blockchain ledger. In some embodiments, only a subset of peers (e.g., a small group of trusted systems out of a larger group of systems of the blockchain network, etc.)

Although the examples herein refer to a host platform that is integrated with a blockchain network/blockchain ledger for storage of data, the data may be stored on other storage types as well and not just a blockchain ledger. For example, any data store such as a database, relational database, topic-based server, cloud platform, distributed database, and the like, may be used.

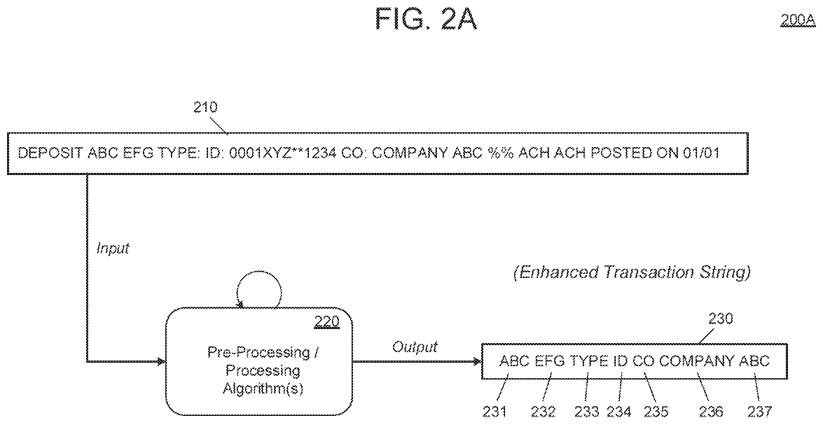

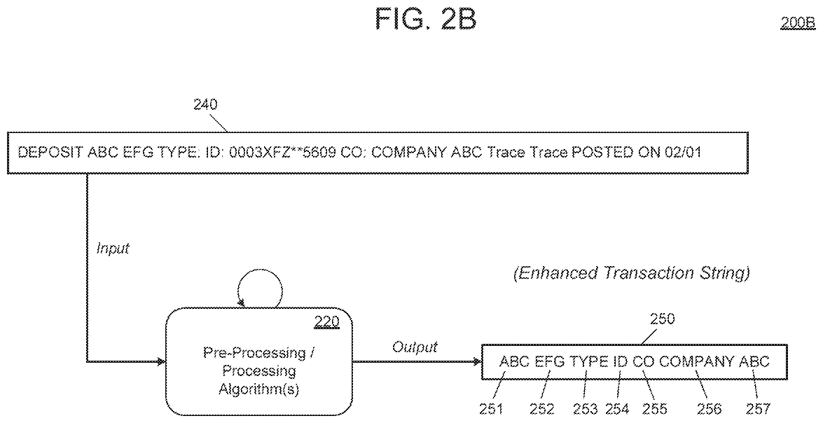

FIGS. 2A-2B illustrate a process for cleaning transaction strings in accordance with example embodiments. Referring to FIG. 2A, a process 200A of enhancing a transaction string 210 is shown. To prepare transaction records for further processing, a transaction string may be pulled from the transaction record and “enhanced” by reducing or removing variability, such as common keywords and identifiers, reference numbers, and the like, from the string. Variability in the transaction string can cause incorrect mappings and the like. By cleaning the string before further processing, the variability can be reduced or removed, making the strings easier to compare and match together. Here, one or more pre-processing algorithms 220 may be executed on an input transaction string 210 to create an enhanced transaction string 230.

The pre-processing algorithms 220 may include, but are not limited to, string parsing operations such as removal of common keywords, removal of variable dates, removal of variable reference numbers, removal of non-word characters, removal of whitespace, standardization, and the like. The result is generally a smaller-sized (less data, fewer words, smaller string size, etc.) transaction string 230 with a pattern of words or tokens 231, 232, 233, 234, 235, 236, and 237, which represent the non-variable aspects of the transaction string; however, it should be noted that expanding these components may add meaning, for example in the case of specifying counterparties and/or transaction types more clearly. The pattern may require both the tokens and the sequence order shown (i.e., 231 followed by 232, followed by 233, etc.). These aspects should be the same or similar for similar transactions. A key purpose of applying these algorithms is to isolate the transaction string variability and make it possible to group transactions together based on the similarity between transaction strings after variability has been removed. This variability reduction or removal allows the host platform to compute features on the deposit source transaction groups such as pay frequency, when combined with additional data automatically extracted from the transaction strings and/or corresponding transaction records for deposit source classification. It should be appreciated that this reduction in variability extends beyond deposit source classification, since identifying other types of transactions, such as transfers between accounts, can help improve classification accuracy by enhanced categorization and/or filtering.

FIG. 2B illustrates another example of a process 200B of enhancing a transaction string 240, which is similar to the process 200A shown in FIG. 2A. Here, an input transaction string 240 includes different string content than the input transaction string 210 shown in FIG. 2A. However, after the host platform applies the pre-processing algorithms 220, a resulting enhanced transaction string 250 is generated which is the same as the enhanced transaction string 230 shown in FIG. 2A. In particular, enhanced transaction string 250 includes tokens 251, 252, 253, 254, 255, 256, and 257 that match the tokens 231, 232, 233, 234, 235, 236, and 237 of the enhanced transaction string 230, and are in the same sequence order. In other words, once the variability is removed from the transaction string 210 and the transaction string 240, the output enhanced transaction strings 230 and 250 are the same.

According to various aspects, a machine learning model may be used to process the enhanced transaction strings output by the pre-processing algorithms 220 to assign categories to the transaction strings that are meaningful for future models which generate additional financial insights from these transaction strings. The machine learning algorithm(s) may include, but is not limited to, tree-based classifications (e.g., decision trees, boosted trees, bagged trees, etc.), discriminant analysis, Naïve Bayes, support vector machines, neural networks, etc. As another example, a deep-learning neural network may be used or the like. Additional machine learning algorithms and processing steps, including clustering (e.g. k-means), topic modeling (e.g. Latent Dirichlet Allocation (LDA)), dimensionality reduction (e.g. Principal Component Analysis (PCA), Singular Value Decomposition (SVD), Independent Component Analysis (ICA)), etc. can be performed to preprocess, pre-group, and/or filter transactions for processing in a system, pipeline, or ensemble of machine learning transactions, to further aid the deposit source classifier model in performing classifications of transaction strings. Moreover, some of those additional machine learning algorithms can be trained, configured, and used to process transaction strings directly, instead of as a pre-processing step, e.g., potentially using mappings of categories to clusters.

As an example of classification, the categories may correspond to different types of income sources (also referred to herein as deposit sources). A deposit source is a source that deposits funds into a user's account. In today's work environment, many people obtain income from multiple sources including a primary source of income and a secondary source of income. People may also have income from government assistance, grants, peers (other people), tenants (rent payments, etc.), and the like. The categories, in this example, may include different types of income such as payroll, peer-to-peer, basic income, childcare, rental income, grants, and the like. The output of the deposit source classification process is a classifier that knows the decision boundary between transaction categories and can be used to process additional transaction such as historical transactions or new and future transactions from that deposit source.

In particular, the category of a transaction is generally not evident when it is ingested in its raw format. One common solution is to identify keywords that could definitively indicate the transaction's category. Unfortunately, such keywords rarely exist in a given transaction string, because transaction strings are machine-generated representations. The examples further described herein are directed to a machine learning model that may be used to classify a transaction string to a deposit source (or other category). The machine learning model may classify transactions where transaction category indicative keywords do not necessarily exist in the transaction string. The methods included in this system enables these transaction classifications to be enhanced by including additional information. For example, additional features such as the frequency that the deposit source deposits transactions, the variability in the deposit source's transaction amounts, etc. can inform and improve these classifications.

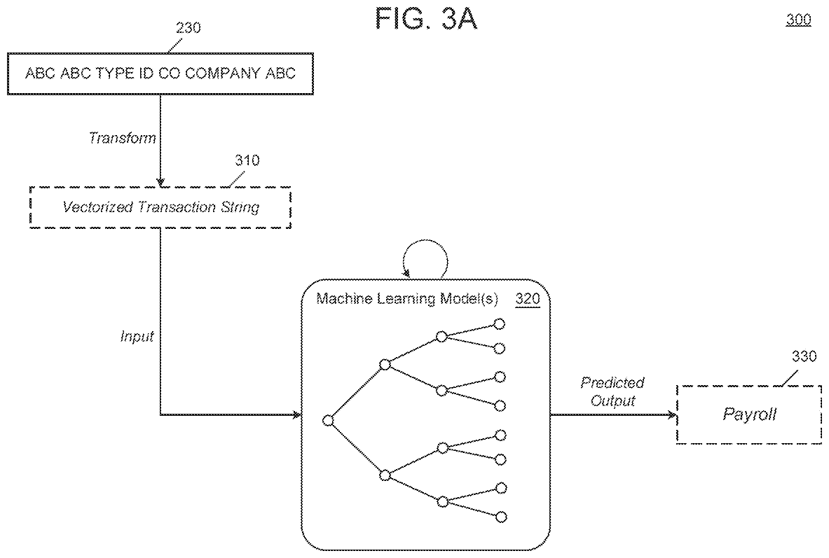

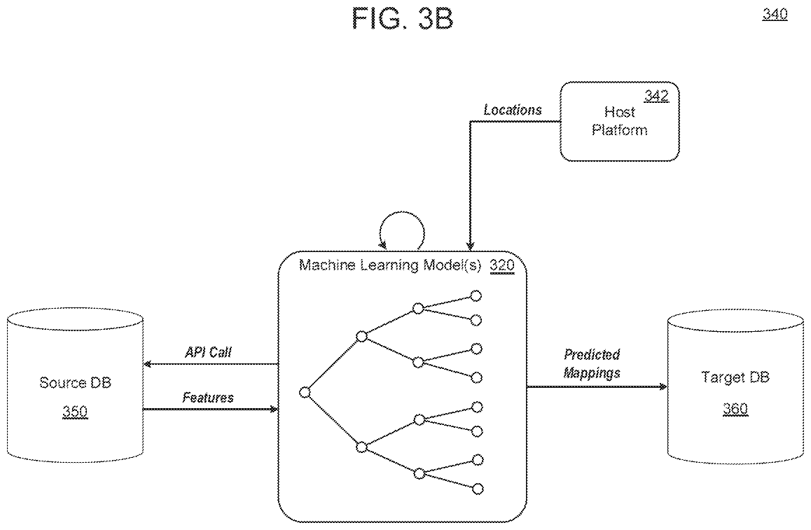

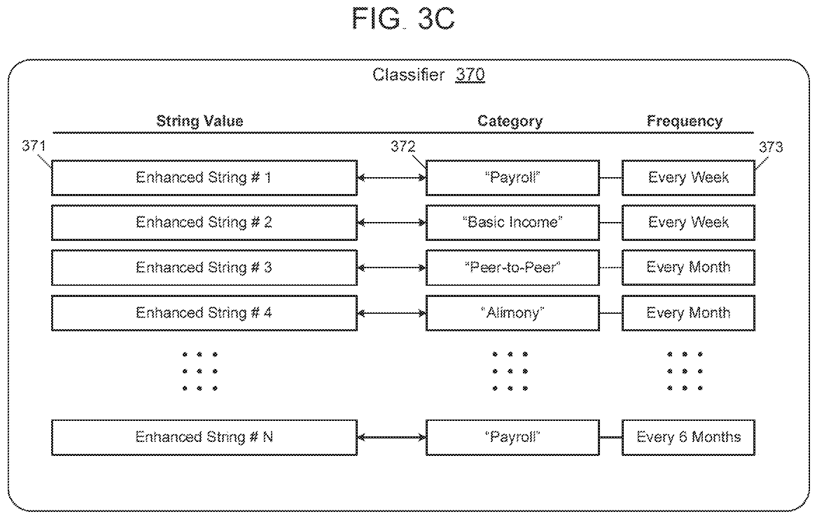

FIG. 3A illustrates an example process 300 of a machine learning model 320 determining a category 330 of a transaction string 230 according to example embodiments. In this example, the transaction string 230 corresponds to the enhanced transaction string generated by the pre-processing algorithms 220 shown in FIGS. 2A-2B. The transaction string 230 may include text content which may be processed by the machine learning model 320. As another example, the machine learning model 320 may require numerical values for processing by a digital computer. In this example, the input transaction string 230 may be transformed into a vector 310 using a vectorization process, encoding process, etc.

The machine learning model 320 may be trained to identify a deposit source classification for the transaction string 230. For example, the machine learning model 320 may determine whether the transaction string 230 corresponds to a payroll transaction, a peer-to-peer transaction, alimony, childcare, basic income, a grant, 1099 income, or any other type of income source. The resulting predicted output is the category 330, which in this example is “payroll”. It is important to appreciate that the machine learning model 320 in this example embodiment could consist of multiple models, including an ensemble or group of ensembles, combined together to predict the output.

The process of classifying transactions strings may be an iterative process that is performed on hundreds, thousands, millions, or more transaction records. FIG. 3B illustrates an example of a processing performed by a host platform for multiple transaction records. As an example, the host platform may control the predictive process as a batch processing process, for example, synchronous batch processing (real-time), asynchronous batch processing (subsequent), by processing each of the individual transactions comprising a batch in real-time streaming systems (e.g., using an Apache Kafka-based streaming system, etc.), by processing mini-batches of transactions, or the like.

Referring to FIG. 3B, a process 340 of processing multiple transaction records in a batch is shown. Here, a host platform 342 may provide location data to the machine learning model 320 (e.g., provide data to a web service or the like which hosts the machine learning model 320, etc.). The location data may include an address or other location of the input data (e.g. feature data) stored within a source database 350. The feature data may include enhanced transaction string records, etc. The location data may also include a storage location for the outputs of the machine learning model 320 (i.e., the predicted classifications of the deposit source, etc.).

The machine learning model 320 may request the input data from the source database 350, for example, via a query, a service, an API call, or the like. In response, the source database 350 may return the input data, transaction strings, transaction records, and the like. The machine learning model 320 may process the transaction strings to create predicted classifications for each of the transaction strings. These predicted classifications can be stored in the target database 360 based on the location data from the host platform 340, or returned directly to the host platform 340 (an example return pathway is not shown in the embodiment depicted in FIG. 3B). In addition to the predicted outputs, the target database may store a more complete record such as a mapping between the category (i.e., deposit source classification value) and the transaction record which may include the original transaction string, the enhanced transaction string, additional transaction record content (e.g., payment date, amount, geographical location, time, counterparty, etc.), the full transaction record, and/or the like.

FIG. 3C illustrates an example of building a classifier 370 from the outputs of the machine learning model 320 in FIG. 3B. For example, the classifier 370 may be built using mappings output by the machine learning model 320 and stored in the target database 350. In a simple example, the classifier 370 may include each of the mappings created by the machine learning model 320. As another example, a service can analyze the mappings created by the machine learning model 320 to identify keys within the mappings which are more relevant for mapping transactions. Each mapping in this example may include a string identifier 371 (e.g., the raw transaction string, the enhanced transaction string, etc.), a category 372 (e.g., the deposit source classification mapped to the string identifier), and a frequency 373 representing the frequency of a payment/deposit from the deposit source. The classifier 370 may be used for further processing of transactions from the user's account(s). For example, the classifier 370 may be applied to historical transaction records of the user and/or to future transaction records of the user.

In some embodiments, the classifier 370 may be generated using only a subset of transaction records from a user's bank account, credit card account, payroll account, employer account, etc. Accordingly, the classifier 370 may be used to classify the remaining transaction records within the user's bank account or accounts. Also, the classifier may be used to classify future transaction records of the user that are received over time.

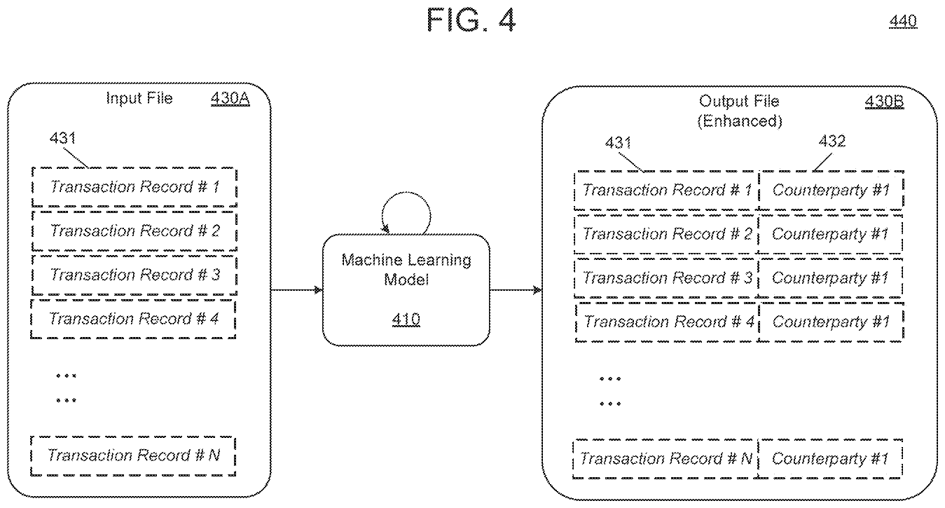

FIG. 4 illustrates a batch processing process 440 for processing of transaction records using a machine learning model 410 such as the classifier 370 of FIG. 3C, in accordance with example embodiments. As previously noted with respect to FIGS. 3A-3C, a batch processing may be performed on multiple transaction records in one or more accounts of the user. The batch processing may be performed in a synchronous manner (e.g., in real-time upon request) or asynchronously (e.g., a periodic task every week, month, etc.). Referring to FIG. 4, the machine learning model 400 may be executed on a plurality of transaction records 431 stored within an input file 430A.

Each transaction record may include a transaction string which has been enhanced using the pre-processing described in FIGS. 2A-2B. The machine learning model 410 may identify a category (e.g., a deposit source classification) for each transaction record and add a label of the identified category to the transaction record in an output file 430B. In FIG. 4, each transaction record 431 is paired with a label 432, which identifies the category of the transaction identified by the machine learning model 410. The machine learning model 410 may iteratively perform this process in jobs until all of the transaction records 431 in the input file 430A are processed and stored in the output file 430B along with the label 432.

The labeled transaction records created by the machine learning model 410 described according to various embodiments may be used for further processing of the transaction records. As an example, the classification process described herein may be a precursor (pre-processing step) for an income verification process such as described in U.S. patent application Ser. No. 17/580,721, filed on Jan. 21, 2022, which is already incorporated herein by reference for all purposes. For example, the classifier 370 may identify which transaction records are income, and which are not. Thus, by using this information as a filter to aid the process, only the transaction records labeled as income may be input to the analytical models used for income verification therein. As another example, only certain types of income (e.g., payroll, etc.) may be input to the analytical models, while the other types of income are not considered or input, thereby reducing the amount of data considered by the income verification process. Naturally, expenses may be included and/or processed in a similar manner.

As another example, the labeled transaction records created by the classifier 370 may be a precursor (pre-processing step) for a reconciliation and deduplication process such as described in Ser. No. 17/835,044, filed on Jun. 8, 2022, in the United States Patent and Trademark Office, which is already fully incorporated herein by reference for all purposes. For example, the classifier 370 may label the transaction records with particular types of deposit source classifications which can be used as an additional data point for matching transaction records together (or identifying transaction records that don't match). The label output by the machine learning model 410 may be given a different weight (e.g., a greater weight, etc.) than the other aspects of the transaction records being compared such as the date value, the amount value, the string value, etc. Accordingly, the machine learning model 410 may help improve the accuracy of the reconciliation and deduplication process.

As another example, the labeled transaction records created by the classifier 370 may be a precursor (pre-processing step) for a benefit administration process such as described in patent application Ser. No. 17/864,589, entitled Benefit Administration Platform, filed on Jul. 14, 2022, in the United States Patent and Trademark Office, which is fully incorporated herein by reference for all purposes. For example, the classifier 370 may label the transaction records with particular types of deposit source classifications which can be used as an additional data point for matching transaction records together (or identifying transaction records that don't match) to verify that the person requesting the benefit has the correct income level.

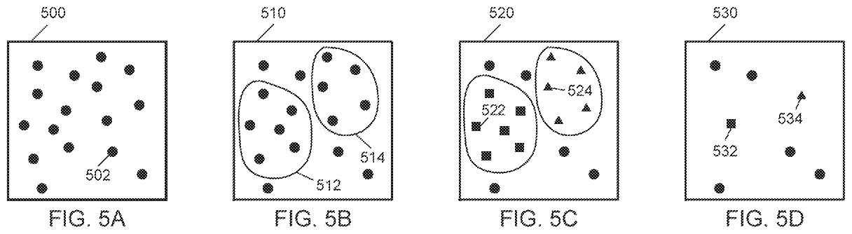

FIGS. 5A-5D illustrate a process of generating transaction exemplars in accordance with example embodiments. In these examples, the host system takes, as input, a plurality of transaction records from deposit transactions as described above, although it could be configured to take payment transactions executed via an electronic terminal such as a point of sale (POS) system, or the like, depending on the particular embodiment. It's important to note and appreciate that this process is not necessarily constrained to any particular class of transactions, but it can be generalized or constrained depending on the goals of the particular embodiment. The transaction records may be stored in a database and retrieved via a database query such as by using a structured query language (SQL) query or the like. As another example, the transaction records may be uploaded in the form of a document. The transaction records may include machine-generated text attributes of the transaction such as a payment account number, expiry, security code, amount, date, geographic location, and the like. In some embodiments, the transaction records may include transaction strings. The transactions may be from one user, multiple users, multiple transactions, different amounts, different purposes, different counterparties, different time periods, and the like.

The host system may vectorize the transaction strings and integrate them into multidimensional vector space 500 as shown in FIG. 5A; it's important to appreciate that two dimensions are depicted in FIG. 5A for clarity, but dimensionality is not inherently constrained. Here, the host platform may read the transaction record from the input, vectorize the transaction records into vectors, and plot them as points 502 in the multidimensional vector space 500. Here, the host system may identify subsets of transactions that are related to one another and group them into clusters automatically using one or more models such as an artificial intelligence model, a machine learning model, heuristics, and the like. These models can be supervised, semi-supervised, unsupervised, and the like. The model may perform the clustering based on features of those transactions, including but not limited to raw transaction strings, e.g., in vectorized format, location information of the transaction, and the like. Here, a plurality of raw transaction strings that have been vectorized to create features, plus transaction information derived from the transaction record, inferred from user input, enhanced by other models (e.g., an ensemble of ML models/heuristics), etc., are shown.

In addition, as shown in FIG. 5B, the host system may group transactions into clusters. To do so, the host system may group vectors into groups 512 and 514 within vector space 510 based on distances (e.g., Euclidean distances, and the like) between the vectors in each group. Here, the natural groupings are based on the actual meaning of the transaction string data and/or other features. In FIG. 5C, the host system generates clusters 522 and 524 from the groupings in vector space 520. Here, the clusters are “islands of meaning” within the transactions, as represented by their locations in multidimensional space, by clustering, grouping, and/or separating using unsupervised, supervised, or other machine learning methodologies. In this example, each of the transactions in each cluster may be very similar such as a same type of transaction.

FIG. 5D illustrates an example of generating transaction exemplars 532 and 534 in multidimensional space 530 based on the clusters 522 and 524 shown in FIG. 5C, respectively. In this example, the host system generates transactions within representative groups or sets of some meaningful grouping of transactions (clusters). These data points may represent transactions that are examples of some group, cluster, class, etc. Thus, they could be exemplars for their respective clusters, or they could be used within a process to find a transaction exemplar, and the like.

Thus, a transaction exemplar represents a condensed data representation of multiple vectors in vector space. In this example, there may be a 1:1 correspondence between these condensed representations and clusters. As another example, a cluster may be represented by more than one condensed representation/point, for example, to define cluster or group boundaries. As another example, a cluster may be represented by no condensed representation/points, to exclude labeling that point and thus to direct transactions toward more meaningful exemplars, e.g., in the case of noise in the data.

The transaction coordinates in multidimensional vector space can be generated in different ways, depending on the context. For example, one potential embodiment of transaction exemplars encodes word embeddings, which are based on semantic meaning of words, so that semantically similar words map to the same representation in multidimensional vector space. The word embeddings may be taken from a transaction record including a transaction string. These relationships may be learned by executing neural networks that are capable of assigning a real value to tokens such that tokens that are synonyms of each other are closer together, compared to tokens that are not. For example, under these conditions one might expect to see transactions with less apparent relationships, such as these transfer transaction examples:

TABLE 1

transfer from fancy mugs llc
tfr fr decorative cups inc
xfr frm platters corporation

Another potential embodiment of transaction exemplars uses context from the originating financial institution more directly. Instead of semantic meaning, examples could consist of more structural relationships such as those that can be derived from the transactions related to a single institution and the token position. The vectorization strategy is more traditional in this case (e.g., count vectorization, TF-IDF, etc.). Transactions one might expect to see in this case might be:

TABLE 2

bank of hogwarts atm deposit 12345 potter blvd
bank of hogwarts atm deposit 23456 gringotts way
bank of hogwarts atm deposit 54321 granger street

As another example, a machine learning vectorizer (e.g., ML model, etc.) that considers a set of transactions from the same institution may be executed on the transactions to vectorize transactions. As another example, a Word2Vec model, which is a natural language processing (NLP) model, may be executed on the transactions (e.g., transaction attributes, strings, etc.) to generate word embeddings using a general credit transactions dataset as the corpus. The Word2Vec model may observe word co-occurrences and predict semantic meaning of a token from the tokens that co-occur with it. For example, consider the following two example transactions string data:

TABLE 3

bank of gryffindor atm deposit
bank of ravenclaw atm deposit

Because the words around the words “gryffindor” and “ravenclaw” are the same, the model may assign them to similar coordinates in the multidimensional vector space.

The model may also identify a cluster of similar/related transactions in the vector space. For example, transactions of the same type may be identified and grouped together in a cluster. Here, a transaction exemplar (i.e., an exemplary transaction) may be generated for the cluster. The exemplary transaction does not need to be a point within the cluster, or even a point within the plurality of transaction records input to this process, but it could be. One example of finding a set of exemplars, i.e., condensed data representations, would be finding groupings of transactions with similar features, and calculating the average coordinates (e.g., centroid, medoid, or the like, which may or may not be weighted in some meaningful way) for that grouping. The coordinates that represent this average could then be used to represent many transactions with a single vector in multidimensional space, which is referred to herein as an exemplar. In some embodiments, the clusters and transaction exemplars may be one-to-one correspondence. That is, each cluster has a single transaction exemplar. However, embodiments are not limited thereto.

An exemplar can be used to classify new data (i.e., new, unseen transaction records), if the new data point (i.e., a new transaction record) is deemed to be similar enough to a particular exemplar. Bank transaction strings are machine generated text strings that describe a transfer of funds from a payor to a payee (counterparties in a transaction, or a same-party transfer, etc.), and depend on the latent factors like the reason for transfer, the time of day, and the financial institutions involved. These are sources of variation in all transaction strings, and generally cause two financial transactions that are substantially the same to appear differently, even if slightly. This variation makes grouping these similar-in-meaning but different-in-form transaction strings a challenge. The exemplar methodology automatically finds these groups of similar text strings and represents them with a single text string or similar representation.

An exemplar representing a grouping of transaction strings that are similar in meaning but different in features and/or appearance allows those transactions to be understood and classified more readily, without having to know all the textual patterns the transactions follow.

It should be appreciated that this method for automatically finding representative exemplars works in high-cardinality spaces, by virtue of finding local “islands of meaning” within the larger “sea” of transaction records. It should be further appreciated that a probabilistic approach can be applied, wherein the frequencies of observed transaction records, as raw records or following processing to remove transient values and/or slight dissimilarities, can be incorporated into the processing technology.

The exemplar generation process may include different steps. For example, suppose that a set of examples S is generated where S is a collection of coordinates in multidimensional vector space, wherein each set of coordinates corresponds to a transaction record. Since S is built iteratively from small subsets of the entire multidimensional space, some exemplars in S may be duplicated when multiple iterations find similar patterns that get logged to S. In short, by the very nature of exemplars representing multiple transactions because they are similar, an exemplar can be “found” multiple times. When this duplication process occurs, the example embodiments may detect and remove the duplicates.

For example, deduplicating, condensing, or reducing a list of exemplars can proceed in much the same way as exemplars are found. By calculating a representative distance (including but not limited to Euclidean distance, etc.) between exemplars, a set of exemplars close to each given point can be found by determining the exemplars that share the shortest distances, while separating groups of points in space, leading to points matched to their closes potential exemplars. The relationship between possible matches is symmetric, so if exemplar A is similar to exemplar B, then B must be similar to A, which means that one will observe both (A, B) and (B, A) in the set of matches, and either A or B can be eliminated as a duplicate representation of the same exemplar. Alternatively, the members of exemplars A and B can be aggregated as or otherwise processed into a single exemplar, or the relationship between A and B can be modeled as members within a hierarchy.

This process may proceed iteratively by condensing clusters until a stopping condition is met, such as when exemplars are no longer close to each other, based on some metric and threshold. For example, when the vectors are more than some threshold distance apart in multidimensional space, then the vectors can be determined to be considered outside of the group/cluster.

Exemplars are created when transactions are less than some distance, e.g. within a Euclidean distance of t units apart in the relevant multidimensional transaction space. The threshold t determines whether two existing exemplars are duplicates, and the threshold may be dynamically chosen, based on heuristics, machine learning, and the like.

For example, let A′, B′, and C′ be three exemplars and t be an arbitrarily-chosen distance threshold. In this example, if Distance(A′, B′)<t, Distance(A′, C′)>t, and Distance(B′, C′)>t, then one can note that Distance(B′, A′)<t as well for this distance threshold t. So, either A′ or B′ could be retained as an exemplar to deduplicate the list, resulting in either exemplars A′ and C′ or B′ and C′ remaining. On the other hand, if instead Distance(A′, B′)<t, Distance(A′, C′)>t, and Distance(B′, C′)<t, then by collapsing A′ or B′ to B′, and then collapsing B′ and C′ to C′, these 3 points could be deduplicated to a single point. It should be appreciated that the collapsing/deduplication process could vary by embodiment, choice of the arbitrary threshold t, and the like. Alternatively to removing candidate exemplars, averaging or otherwise processing these points to condense them could proceed in a similar fashion.

The exemplar creation process may receive as input a set of transactions, find exemplars, and store them as a list, array, or the like, which may be held in a computer memory, permanent or transient file, database, repository, blockchain, or the like. As processing of new transaction records occurs, when more transactions are found to be close to an existing exemplar, it may be appropriate to update the centroid or other representation that represents the exemplar in multidimensional space. This process may essentially resemble exemplar deduplication, but with the added nuance of updating the centroid or other appropriate measure of centrality with the information from a new duplicate exemplar or set thereof.

As an example, c is a centroid vector of exemplar E and let c′ be the centroid vector of exemplar E′. If E′ is close enough to E (i.e., Distance(E, E′)<t, for some threshold t), then E′ is a duplicate of E and thus E′ can be removed from the list, followed by the update of c to be WeightedAverage(c, c′), using weights derived from the number of transaction records that each exemplar is derived from. For example, if c is the average of 5 transaction records and c′ is the average of 7 transaction records, then WeightedAverage(c, c′)=[(5/12)*c]+[(7/12)*c′].

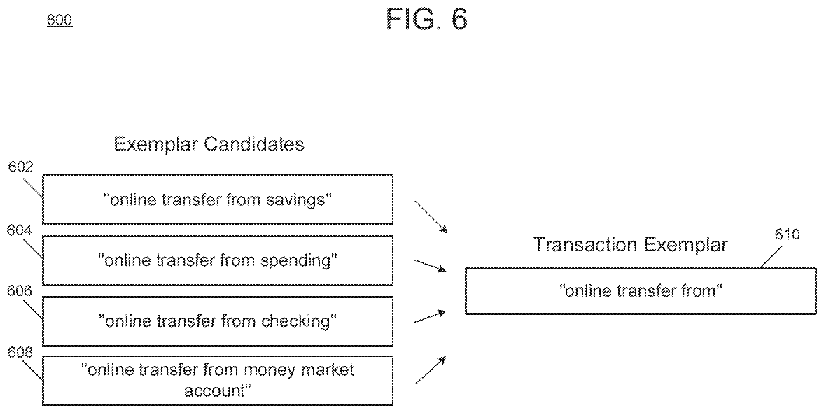

FIG. 6 illustrates a process 600 of mapping transaction candidates to a transaction exemplar in accordance with an example embodiment. Referring to FIG. 6, four input transaction strings 602, 604, 606, and 608 from a same cluster contain similar transaction content including the phrase “online transfer from . . . ”. The machine learning model described herein may convert the transaction strings 602, 604, 606, and 608, into vector space and compare the vectors to identify a transaction exemplar 610. The transaction exemplar 610 is identified from the cluster formed by these transaction exemplar candidates in the vector space based on the input transactions that have been modeled in the relevant multidimensional vector space.

Some transaction exemplars do not have a string representation, but rather a vector representation that corresponds to the centroid (or other representation of centrality or central tendency) of the exemplar in vector space. Other transaction exemplars can be created for the purposes of reducing the dimensions given the institution and token position context. In this case, the transaction exemplar can be represented by the concatenated tokens that each underlying exemplar member has in common.

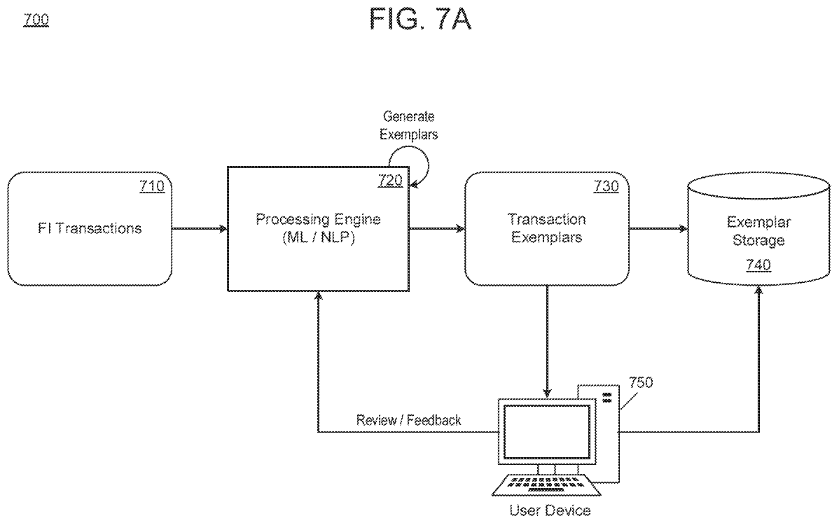

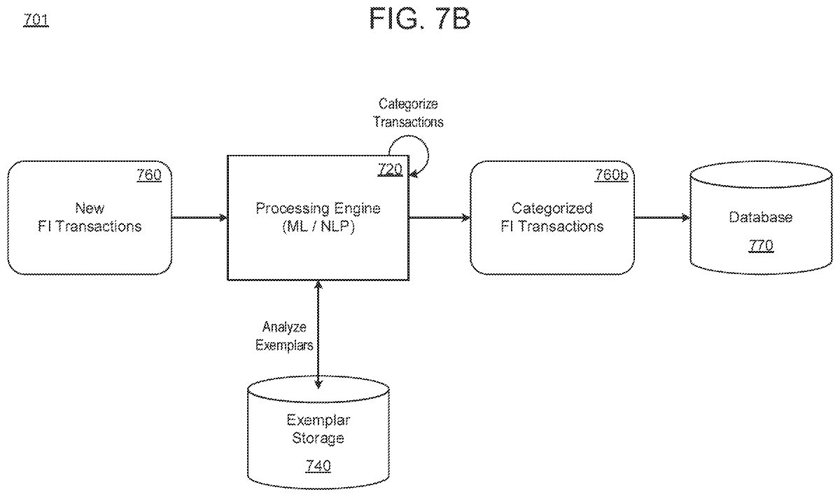

FIG. 7A illustrates a process 700 of generating transaction exemplars in accordance with an example embodiment. Referring to FIG. 7A, a processing engine 720 hosted by the host platform described herein may receive a set of input transaction records 710, which may be pre-processed as described in the text above, and generate transaction exemplars 730 from the set of input transaction records. The transaction exemplars can be recorded, in vector form, within the storage 740. As a result, the transaction exemplars are already in a format that can be input to a machine learning model.

Here, the transaction records 710 may be provided from an input source, e.g., a plurality of transaction records from one or more financial institutions, and the transaction records 710 may be pre-processed or used in a raw format, as appropriate. Here, the processing engine 720 may vectorize the transactions, create features, cluster the vectors in vector space, and extract the transaction exemplars, etc. The clusters may be identified using ML algorithms, distance metrics, and parameters such as distance thresholds (e.g., Euclidean distance, etc.).

According to various embodiments, the process 700 may include a review process such as a human-in-the-loop to provide feedback on the transaction exemplars 730 output by the processing engine 720. For example, a user may supply feedback indicating a transaction exemplar is correct or is not correct, is good or bad, etc. The user feedback along with the transaction exemplar may be input to the machine learning model to further train the model to better identify transaction exemplars in the future. As another example, the review process may be performed by computers programmed with AI/ML algorithms and/or heuristics to assess quality, etc.

FIG. 7B illustrates a process 701 of categorizing transactions based on previously generated transaction exemplars in accordance with an example embodiment. Referring to FIG. 7B, the transaction exemplars 730 generated in FIG. 7A, and stored within the storage 740, can be used to categorize newly received/input transaction records. For example, in FIG. 7B, a new set of transaction records 760 are input to the processing engine 720. The processing engine 720 may convert the new set of transaction records 760 into vectors and compare them to the transaction exemplars 730 that are stored in the database 740 to generate categorized transactions 760b which are labeled/grouped based on a transaction exemplar from the database 740. Here, the processing engine 720 may match a new transaction record to a previously existing transaction exemplar using machine learning, natural language processing, etc.

In this and other example embodiments, the exemplars could be available for input to other models within the pipeline. When processing a significant amount of transaction records, it is reasonable to expect a lot of diversity in the transaction strings. To efficiently process the strings, the host system can use exemplars to label some of the transactions as exemplars. In doing so, the transactions that are known are assigned to a particular exemplar. The review process may provide enough information to stand as an exemplar, for example, by correcting the example. As another example, the review process may identify a different transaction as the exemplar, etc. Moreover, as a further clarifying example, it should be appreciated that in some embodiments, exemplars could be used as a component within or to form the whole of a host platform 120's translation service 122, as specified in U.S. patent application Ser. No. 17/342,622 FIG. 1, to classify transactions and/or extract counterparty entities, either alone or as part of the ML Model(s) in that translation service 122. Exemplars could provide routing/orchestrating for further processing and/or classifying directly.

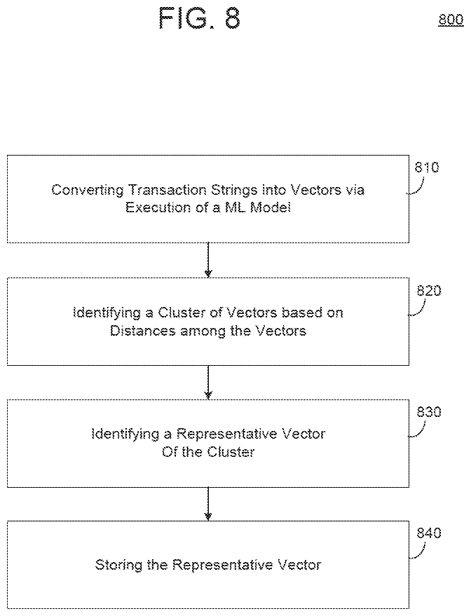

FIG. 8 illustrates a method 800 of generating a transaction exemplar in accordance with example embodiments. For example, the method 800 may be performed by a host platform as described herein. Referring to FIG. 8, in 810, the method may include converting a plurality of transaction strings corresponding to a plurality of transactions into a plurality of vectors in multidimensional vector space, respectively, via execution of a machine learning model on the plurality of transaction strings. The conversion may include processing the transaction stings into vectors via machine learning and integrating the vectors into the multidimensional space (vector space).

In 820, the method may include identifying a cluster of vectors in the multidimensional space that correspond to a subset of transactions among the plurality in a cluster or group of transactions that are related based on distances between the vectors within a cluster of vectors in the multidimensional space. For example, the cluster may be identified based on distances between the vectors within the multidimensional vector space. In 830, the method may include identifying a representative vector within the cluster that corresponds to an exemplary transaction of the subset of transactions based on the cluster of vectors. In 840, the method may include storing the representative vector within a data store or on an appropriate blockchain.

In some embodiments, the identifying may include iteratively reducing the plurality of vectors based on a dynamically changing criteria to generate the cluster of vectors. In some embodiments, the iteratively reducing the plurality of vectors may include dynamically changing a distance threshold allowed between vectors in the cluster. In some embodiments, the method may further include converting a plurality of additional transaction strings into a plurality of additional vectors, identifying additional vectors within the cluster of vectors, and modifying the representative vector within the cluster based on the additional vectors.

In some embodiments, the identifying may include identifying a centroid of the cluster of vectors within the multidimensional vector space as the representative vector within the cluster of vectors. In some embodiments, the identifying may include selecting a vector from among the cluster of vectors as the representative vector within the cluster based on a predetermined criteria. In some embodiments, the identifying may include identifying duplicate vectors among the plurality of vectors in the multidimensional vector space, and removing the duplicate vectors prior to identifying the cluster of vectors. In some embodiments, the method may further include receiving a new group of transaction strings, converting the new group of transaction strings into a group of vectors in multidimensional space, and identifying a transaction among the new group of transactions that corresponds to the exemplary transaction based on a comparison of the group of vectors to the representative vector in multidimensional vector space. It's also important to appreciate that exemplars may need to be refined over time, as additional data is gathered, and a retraining process is to be expected in normal operations of example embodiments.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

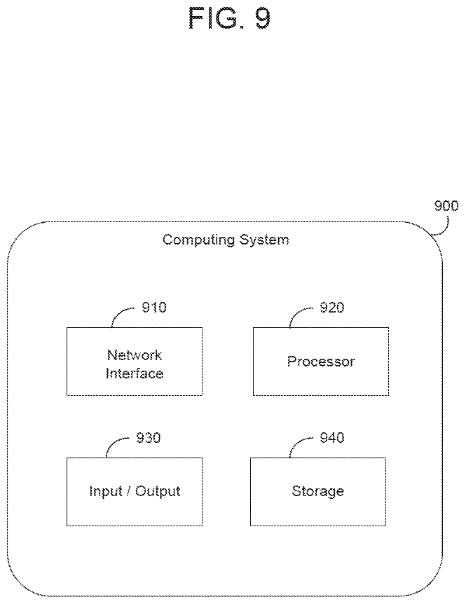

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative configuration, the processor and the storage medium may reside as discrete components. For example, FIG. 9 illustrates an example computing system 900 which may process or be integrated in any of the above-described examples, etc. FIG. 9 is not intended to suggest any limitation as to the scope of use or functionality of embodiments described herein. The computing system 900 is capable of being implemented and/or performing any of the functionality set forth hereinabove.

The computing system 900 may include a computer system/server, which is operational with numerous other general purpose or special purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 900 may be, contain, or include a tokenization platform, server, CPU, or the like.

The computing system 900 may be described in the general context of computer system-executable instructions, such as program modules, being executed by a computer system. Generally, program modules may include routines, programs, objects, components, logic, data structures, and so on that perform particular tasks or implement particular abstract data types. The computing system 900 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 9, the computing system 900 is shown in the form of a general-purpose computing device. The components of computing system 900 may include, but are not limited to, a network interface 910, a processor 920 (or multiple processors/cores), an input/output 930, which may include a port, an interface, etc., or other hardware, for outputting a data signal to another device such as a display, a printer, etc., and a storage device 940, which may include a system memory, or the like. Although not shown, the computing system 900 may also include a system bus that couples various system components, including system memory to the processor 920.

The storage 940 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 940 can read and write to a non-removable, non-volatile magnetic media (not shown and typically called a “hard drive”) and/or a solid state drive (SSD). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media, and/or a flash drive, such as USB drive or an SD card reader for reading flash-based media, can be provided. In such instances, each can be connected to the bus by one or more data media interfaces. As will be further depicted and described below, storage device 940 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 900 may also communicate with one or more external devices such as a keyboard, a pointing device, a display, etc.; one or more devices that enable a user to interact with computer system/server; and/or any devices (e.g., network card, modem, etc.) that enable computing system 900 to communicate with one or more other computing devices. Such communication can occur via I/O interfaces. Still yet, computing system 900 can communicate with one or more networks such as a local area network (LAN), a general wide area network (WAN), and/or a public network (e.g., the Internet) via network interface 910. As depicted, network interface 910 may also include a network adapter that communicates with the other components of computing system 900 via a bus. Although not shown, other hardware and/or software components could be used in conjunction with the computing system 900. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

1. A computing system comprising:
a data store; and
a processor configured to
convert a plurality of transaction strings corresponding to a plurality of transactions into a plurality of vectors in multidimensional vector space, respectively, via execution of a machine learning model on the plurality of transaction strings,
identify a cluster of vectors in the multidimensional space that correspond to a subset of transactions among the plurality of transactions that are related based on distances between the cluster of vectors in the multidimensional space,
identify a representative vector within the cluster that corresponds to an exemplary transaction of the subset of transactions based on the cluster of vectors, and
store the representative vector within the data store.

2. The computing system of claim 1, wherein the processor is configured to iteratively reduce the plurality of vectors based on dynamically changing criteria to generate the cluster of vectors.

3. The computing system of claim 2, wherein the processor is configured to iteratively reduce the plurality of vectors based on a dynamically changing distance threshold allowed between vectors in the cluster.

4. The computing system of claim 1, wherein the processor is further configured to convert a plurality of additional transaction strings into a plurality of additional vectors, identify additional vectors within the cluster of vectors, and modify the representative vector within the cluster based on the additional vectors.

5. The computing system of claim 1, wherein the processor is configured to identify a centroid of the cluster of vectors within the multidimensional vector space as the representative vector within the cluster of vectors.

6. The computing system of claim 1, wherein the processor is configured to select a vector from among the cluster of vectors as the representative vector within the cluster based on a predetermined criteria.

7. The computing system of claim 1, wherein the processor is configured to identify duplicate vectors among the plurality of vectors in the multidimensional vector space, and remove the duplicate vectors prior to identifying the cluster of vectors.

8. The computing system of claim 1, wherein the processor is further configured to receive a new group of transaction strings, convert the new group of transaction strings into a group of vectors in multidimensional space, and identify a transaction among the new group of transactions that corresponds to the exemplary transaction based on a comparison of the group of vectors to the representative vector in multidimensional vector space.

9. A method comprising:
converting a plurality of transaction strings corresponding to a plurality of transactions into a plurality of vectors in multidimensional vector space, respectively, via execution of a machine learning model on the plurality of transaction strings,
identifying a cluster of vectors in the multidimensional space that correspond to a subset of transactions among the plurality of transactions that are related based on distances between the cluster of vectors in the multidimensional space,
identifying a representative vector within the cluster that corresponds to an exemplary transaction of the subset of transactions based on the cluster of vectors, and
storing the representative vector within a data store.

10. The method of claim 9, wherein the identifying comprises iteratively reducing the plurality of vectors based on dynamically changing criteria to generate the cluster of vectors.

11. The method of claim 10, wherein the iteratively reducing the plurality of vectors comprises dynamically changing a distance threshold allowed between vectors in the cluster.

12. The method of claim 9, wherein the method further comprises converting a plurality of additional transaction strings into a plurality of additional vectors, identifying additional vectors within the cluster of vectors, and modifying the representative vector within the cluster based on the additional vectors.

13. The method of claim 9, wherein the identifying comprises identifying a centroid of the cluster of vectors within the multidimensional vector space as the representative vector within the cluster of vectors.

14. The method of claim 9, wherein the identifying comprises selecting a vector from among the cluster of vectors as the representative vector within the cluster based on a predetermined criteria.

15. The method of claim 9, wherein the identifying comprises identifying duplicate vectors among the plurality of vectors in the multidimensional vector space, and removing the duplicate vectors prior to identifying the cluster of vectors.

16. The method of claim 9, wherein the method further comprises receiving a new group of transaction strings, converting the new group of transaction strings into a group of vectors in multidimensional space, and identifying a transaction among the new group of transactions that corresponds to the exemplary transaction based on a comparison of the group of vectors to the representative vector in multidimensional vector space.

17. A computer-readable medium comprising instructions which when executed by a processor cause a computer to perform a method comprising:
converting a plurality of transaction strings corresponding to a plurality of transactions into a plurality of vectors in multidimensional vector space, respectively, via execution of a machine learning model on the plurality of transaction strings,
identifying a cluster of vectors in the multidimensional space that correspond to a subset of transactions among the plurality of transactions that are related based on distances between the cluster of vectors in the multidimensional space,
identifying a representative vector within the cluster that corresponds to an exemplary transaction of the subset of transactions based on the cluster of vectors, and
storing the representative vector within a data store.

18. The computer-readable medium of claim 17, wherein the identifying comprises iteratively reducing the plurality of vectors based on dynamically changing criteria to generate the cluster of vectors.

19. The computer-readable medium of claim 18, wherein the iteratively reducing the plurality of vectors comprises dynamically changing a distance threshold allowed between vectors in the cluster.

20. The computer-readable medium of claim 17, wherein the method further comprises converting a plurality of additional transaction strings into a plurality of additional vectors, identifying additional vectors within the cluster of vectors, and modifying the representative vector within the cluster based on the additional vectors.
